(19) United States
(12) Patent Application Publication
(10) Pub. No.: US 2006/0221328 A1
(43) Pub. Date: Oct. 5, 2006

(54) Automatic homing systems and other sensor systems

(76) Inventor: Ovi Chris Rouly, McLean, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/135,443

(22) Filed: May 24, 2005

Related U.S. Application Data
(60) Provisional application No. 60/668,068, filed on Apr. 5, 2005.

(51) Int. Cl. G01C 3/08; G01B 11/26

(52) U.S. Cl. 356/139.04; 356/3.01; 244/3.16

(57) ABSTRACT

Automatic homing systems are disclosed, operable between pairs of objects. One or both of the objects in the pair may be moving and/or unmanned. Examples of a pair of objects between which the inventive automatic homing systems may be operated are ground vehicles in leader-follower configuration, as well as aircraft, spacecraft, watercraft. The automatic homing systems are based on a relatively simple, elegant concept of rightness/leftness and a line-of-sight link between a respective leader vehicle and follower vehicle. Complex EO/IR cameras, LIDAR, RADAR, and/or SONAR-based sensor systems can be avoided. Convoys of vehicles in leader-follower configuration advantageously may be operated without needing human operators in the follower vehicles.

### RELATED APPLICATION

This claims benefit of U.S. provisional application Ser. No. 60/668,068 filed Apr. 5, 2005 titled “Sensor System.”

### FIELD OF THE INVENTION

The present invention generally relates to automatic direction finding sensor systems, especially to vehicular leader-follower systems and other automatic homing systems.

### BACKGROUND

Certain leader-follower vehicle applications have been disclosed, of which ground vehicle convoys and unmanned robotic vehicles are particularly mentioned. The following are mentioned as examples of leader-follower applications disclosed in the patent literature:

U.S. Pat. No. 5,521,817 by Burdoin et al. issued May 28, 1996 to Honeywell, Inc. for “Airborne drone formation control system,” discloses remote controlled drones. The follower drone is said to control itself to follow the movements of its leader. Use of GPS is mentioned.

U.S. Pat. No. 6,842,674 by Solomon issued Jan. 11, 2005 for “Methods and apparatus for decision making of system of mobile robotic vehicles” discloses mobile robotic vehicles (MRVs) in which a leader issues orders to follower MRVs along an insect model.

In a leader-follower application, the problem of causing the follower vehicle to properly home in on the leader vehicle has been complicated. Before the present invention, the homing problem in leader-follower applications has only been preliminarily addressed, with complex proposed solutions. For example, Daimler-Chrysler has demonstrated a leader-follower system called Chauffeur that uses EO/IR video and radar sensors for lateral and longitudinal follower vehicle control, respectively. Before the present invention, the only leader-follower proposed solutions being mentioned relied on complex electro-optical (EO) and Infra-Red (IR) cameras, LIDAR, RADAR, and/or SONAR-based sensor systems. A simple solution for automatic homing in leader-follower application has been elusive.

### SUMMARY OF THE INVENTION

The present inventor has solved a group of homing problems by inventive homing systems applicable to pairs of objects (such as, e.g., ground vehicles, watercraft, aircraft, spacecraft, etc.) wherein one or both of the objects are moving (such as moving in two-dimensions or three-dimensions) and one or both of the objects may be unmanned. Examples of objects to which the present invention may be applied may be a ground vehicle, watercraft, aircraft, spacecraft, an object worn by or attached to a person, etc., wherein objects used in a pair may be the same or different (i.e., a pair of ground vehicles or a pair consisting of a ground vehicle and another object). In the present invention, when paired objects are disposed in line of sight (LOS) of each other, with one object having disposed thereon an automatic frequency emitter emitting at least two frequencies (preferably at least two frequencies wherein the frequencies are in a range of light, most preferably, laser light), the other object may automatically follow that object having the emitter disposed thereon, with the following being accomplished by using an automatic detector that detects the emitted frequencies, with the detecting and following operations most preferably accomplished completely without needing a human operator. The need for human operators may be eliminated in certain contexts, such as dangerous operations.

In a first preferred embodiment, the invention provides an automatic homing method, comprising at least the steps of: emitting light of at least two different frequencies; and automatically detecting the emitted light, such as, e.g., a homing method wherein the light-emitting step is associated with a first object and the light-detecting step is associated with a second object, wherein the first object and second object are in vehicular leader-follower configuration (such as, e.g., a homing method wherein the first object and the second object are in line of sight (LOS) but are not in physical contact); a homing method wherein the different-frequency light is emitted along a single, common axis (such as, a homing method wherein UV light and IR light are emitted along a single, common axis); a homing method wherein the different-frequency light is emitted at the same time; a homing method wherein light of one frequency is emitted at a different time than light of another frequency; a homing method wherein the light-emitting step is performed by an array of light sources mounted on a central rear portion of a vehicle, and the light-detecting step is performed by an automatic sensor system mounted on a follower vehicle (wherein the pair of vehicles may be inhabited or uninhabited, in any combination); a homing method including at least one automated step selected from a return-to-null step and a distance-by-triangulation step; an automatic homing in which the automatic detection of emitted light occurs at a moveable object having an adjustable course and the method including, after automatically detecting the emitted light, a step of automatically adjusting the course of the moveable object at which the automatic detection occurs; a homing method wherein the light emitting step is automated; and other homing methods.

In another preferred embodiment, the invention provides an automatic direction finder system operating between at least a first object which is a leader object and a second object which is a follower object, wherein either or both objects may be moving, wherein the system comprises: a multiple light automatic direction finder (mLADF) system in which multiple light sources are arrayed, the multiple light sources including at least a first-frequency emitting source and a second-frequency emitting source, such as, e.g., an automatic direction finder system wherein at least two different respective frequencies of light are emitted along a single, common axis (such as, e.g., at least UV light and IR light being emitted along the single, common axis); an automatic direction finder system in which the multiple light sources are arrayed in a fan-like array; an automatic direction finder system wherein the multiple light sources are positioned laterally along an axis (such as, e.g., an automatic direction finder system wherein the axis is horizontal and the MLADF system is in a ground vehicle leader-follower configuration); an automatic direction finder system including at least a return-to-null system and/or a distance-by-triangulation system; etc.

The invention in a further preferred embodiment provides an automatic direction finder system operating between at least a first object which is a leader object and a second object which is a follower object, wherein either or both objects (such as, e.g., an inhabited vehicle, an uninhabited vehicle, etc.) may be moving, wherein the system comprises: a light source assembly that emits light (such as, e.g., at least one of incandescent lamps; semiconductor light emitting diodes (LEDs); light pipes; laser diodes, etc.; a linear array of two independent banks of light sources arranged in a radial, fan-like pattern servicing a single, common axis; etc.) and a multi-carrier detector assembly that senses light emitted by the light source assembly; such as, e.g., an automatic direction finder system wherein the first object and the second object are in line-of-sight (LOS) of each other, with the first object having associated with it the light source assembly and the second object having associated with it the detector assembly; an automatic direction finder system wherein the automatic direction finder system includes a set of signaling outputs that encode longitudinal and lateral spatial relationships between the first object and the second object; an automatic direction finder system applied in a space-based setting, an airborne setting, a ground vehicle homing setting, a convoy setting, etc.; an automatic direction finder system wherein the system is operated between two objects and the two objects are not required to be in physical contact with each other; an automatic direction finder system wherein the two objects are ground vehicles in a leader-follower setting; an automatic direction finder system wherein none of electro-optical (EO) sensors, infra-read (IR) cameras, LIDAR, RADAR or SONAR-based sensor systems is needed; an automatic direction finder system wherein optically the linear array is separated into two halves, with each half of the array emitting a respective unique frequency of light (such as, e.g., an automatic direction finder system wherein one half of the array emits UV light and the other half of the array emits IR light); etc.

In another preferred embodiment, the invention provides a homing device system, wherein none of electro-optical (EO), infra-red (IR) cameras, LIDAR, RADAR or SONAR-based sensor systems is needed, such as, e.g., a homing device system comprising a vehicular leader-follower system; a homing device system in two dimension; a homing device system in three dimensions; a homing device system in four dimensions; etc.

In yet another preferred, the invention provides a homing system for leader-follower ground vehicles, comprising: a leader ground vehicle from which is emitted at least one radio frequency and a follower ground vehicle having an automatic detection device automatically detecting the at least one radio frequency emitted from the leader ground vehicle, such as, e.g., a homing system wherein only one frequency is emitted by the leader ground vehicle and the only one frequency is automatically detected by the automatic detection device, wherein the automatic detection device comprises a fast processor; a homing system wherein at least two frequencies are emitted by the leader ground vehicle and the at least two frequencies are automatically detected by the automatic detection device; a homing system wherein at least one light (such as laser) frequency is emitted and automatically detected.

Optionally, inventive systems, methods, products and devices preferably include performance of direct read-out indication of lateral vector magnitude and longitudinal pulse width modulated (PWM) displacements for the follower object.

In another preferred embodiment, the invention provides a convoy of vehicles in leader-follower configuration, being operated (such as, e.g., being operated on a highway, being operated in a city, being operated on roads, being operated off-roads, being operated in airspace, etc.) without human operators in the follower vehicles, such as, for example, a convoy of vehicles being operated under conditions in which the convoy is being subjected to attack conditions, a convoy of vehicles used in fire-fighting, a convoy of vehicles being sent into a region of dangerous conditions, a convoy of vehicles being sent to receive people for evacuation, etc.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an inventive embodiment which is an exemplary Multiple Light Automatic Direction Finder as a conceptual block diagram.

FIG. 2 depicts the Multiple Light Automatic Direction Finder of FIG. 1 in relative horizontal and vertical offset views.

FIG. 3 is a schematic block diagram view of a general embodiment of the invention. FIG. 3A corresponds to FIG. 3 in a ground vehicle leader-follower case.

### DETAILED DESCRIPTION OF A PREFERRED EMBODIMENT OF THE INVENTION

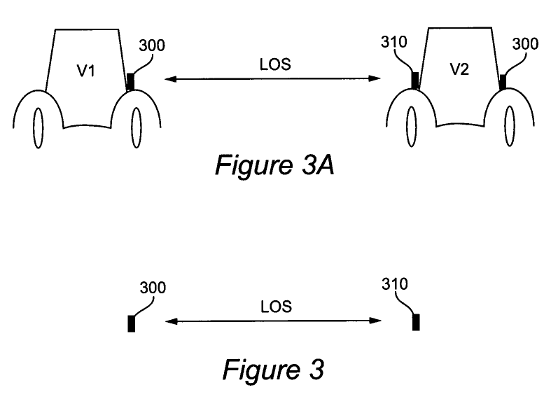

Referring to FIG. 3, the present invention provides an automated homing system operating between two objects where one object includes or has attached to it an emitter system 300 according to the invention and the other object includes or has attached to an automated decoder system 310 according to the invention. Examples of the objects are, e.g., ground vehicles, watercraft, aircraft, spacecraft, self-propelled objects, ballistics objects, tethered objects, etc., which two objects may be the same or different. The respective objects may be moving or not moving in any combination. The respective objects may be unmanned or manned in any combination. The attachment of emitter system 300 and/or decoder system 310 is not particularly limited, and each may respectively be attached to any object physically capable of bearing emitter system 300 or decoder system 310.

A particularly important example of a pair of objects to which the present invention applies is ground vehicles with a leader vehicle V1 (FIG. 3A) being followed by a follower vehicle V2. Leader vehicle V1's movement may be automatically tracked by follower vehicle V2 in the invention. Especially in case of unmanned vehicles V1 and/or V2, a leader-follower ground vehicle system is an important subset of the homing problem solved by the present invention.

Referring to emitter system 300 (FIG. 3), the invention provides for the use of at least one radio frequency, preferably a frequency in the range of light, most preferably a frequency in the range of laser light. Laser light is most preferred as a frequency for use in the present invention, because of its orthogonal nature. Laser light follows a phasing path and can be polarized so that it is not lost. Sound, for example, by contrast to laser light, would tend to disperse and therefore would be less desirable in a homing application. While laser light is mentioned as a preferred frequency for use in the present invention, the invention is not limited thereto and non-laser frequencies may be used. When light is used in the present invention, examples of methods of light emission and light distribution are, e.g., incandescent lamps, semiconductor light emitting diodes (LEDs), light pipes, Laser diodes, etc.

In the invention, preferably line-of-sight LOS (FIG. 3) is maintained between emitter system 300 (associated with its respective leader object) and decoder system 310 (associated with its respective follower object). So long as line-of-sight LOS is maintained, there is no particular maximum distance between the emitter system 300 and the decoder system 310. In a case of a pair of leader-follower ground vehicles each of which is moving, an example of a distance therebetween is, e.g., 50 meters, but may be more or less. In a case of a pair of spacecraft each of which is moving, an example of a distance therebetween is, e.g., kilometers or more. The maximum permissible distance between a respective leader and follower object in the invention is largely a function of the power of the emitting source, such as the emitting laser source. When using light sources (such as lasers) for emitting the frequency or frequencies, preferably the laser or other light source is designed to penetrate interfering conditions (such as dust, smoke, etc.) that may be encountered. A preferred frequency-emitting source to use in the present invention is a laser that travels well through dust, smoke and other interfering conditions.

Where the application depends on the follower object being in line-of-sight of the leader object, the line-of-sight is maintained as follows. For a pair of vehicles in leader-follower configuration, line-of sight is maintained by operation of the controller, which processes and acts upon the output from the receiver via at least the steering mechanism. The controller can be in a range from a crude controller to a complex, sophisticated controller with a system of filters. The controller may be provided as appropriate for the context in which the vehicle will be operated. For example, if only straight-line, non-city operation is required, a relatively crude controller may be feasible. In another example, if one truck is to follow another truck through a city environment, it may be undesirable for the controller in the following truck to permit that follower vehicle to cut corners and travel over a sidewalk, for example, in its following of the leader vehicle. Rather, a customized controller may be more appropriate, in which the controller would require a wide swing in effecting the following of the leader vehicle.

While not all embodiments of the invention require line-of-sight, preferred embodiments have been mentioned in which line-of-sight is required. In such cases, the possibility of the requisite line-of-sight being lost preferably may be addressed in systems associated with the follower vehicle, such as by loss of line-of-sight being defined as an error state (which, correspondingly, may be associated with one or more operational commands, such as the follower vehicle being actuated to park itself, etc.).

In a preferred embodiment of the invention, a convoy of vehicles may be operated, with a leader vehicle followed by a first follower vehicle which itself serves as a leader vehicle in turn followed by a second follower vehicle, etc. In such a convoy, in the event that a first follower vehicle is no longer emitting a signal for the second follower vehicle to automatically detect, so that it is no longer possible for the second follower vehicle to follow the leader vehicle indirectly via the first follower vehicle, instead it may be possible for the second follower vehicle to automatically detect the signal being emitted from the leader vehicle and thus to directly follow the leader vehicle.

In the present invention, preferably two or more different unique frequencies are being emitted from the leader object, each unique frequency at a respective unique position on or in the leader object.

Although using two or more different frequencies of wave-emitting sources has been mentioned as a preferred embodiment, the invention also includes use of as few as only one frequency of light, as long as the processor on the detecting end is fast enough (and, preferably, the homer can see (i.e., is in line of sight with) the light-emitting source).

Without the invention being in any way limited thereto, some examples of using the invention, in various embodiments, are mentioned as follows.

### Comparative Example 1

Typical vehicular leader-follower technologies rely on complex electro-optical (EO) and Infra-Red (IR) cameras, LIDAR, RADAR, and/or SONAR-based sensors. For example, Daimler-Chrysler has demonstrated a leader-follower system called Chauffeur that uses EO/IR video and radar sensors for lateral and longitudinal follower vehicle control, respectively. (Report on CHAUFFEUR Study Mission, Advanced Cruise-Assist Highway System Research Association, publication date not known, was found at http://www.ahsra.orjp/ eng/c04e/comm_coop/report4.htm.) The complexity of the sensor systems that others are proposing and demonstrating often results in significant computational latency, repair and maintenance, configuration requirements, and unique installation hardware and/or driver software requirements (with associated high costs). These complications and costs can be severe.

### Comparative Example 2

Automatic direction finder (ADF) systems have been conventionally used in aviation, where a pilot in an aircraft modifies the direction of the aircraft that he is flying based on whether the aircraft is to left or right of a signal emitted by a fixed location at the airport. The aviation ADF system assumes a fixed location of the signal-emitter. The aviation ADF system also assumes that the aircraft that is homing-in on the emitted signal is piloted and that it is the pilot who interprets what course correction(s) are desired. An aviation ADF system is relatively expensive, on the order of $10,000 for the signal-transmitting box which is installed at a fixed location at the airport.

### Comparative Example 3

For an example of a device for a driver to locate his parked vehicle, see, e.g., U.S. Pat. No. 6,838,987 by Quinonez issued Jan. 4, 2005 for “Vehicle locating system.”

### Inventive Example 1

### (Multiple Light Automatic Direction Finder (mLADF))

An emitter/sensor system has been designed that is a multiple Light Automatic Direction Finder (mLADF). The mLADF system of this Example 1 consists of a light source (emitter) assembly and a multi-carrier detector (sensor) assembly. The purpose of the mLADF system is to provide a set of signaling outputs that encode the longitudinal and lateral spatial relationships between two self-propelled, ballistic, and/or tethered vehicles in any combination. The system may be applied in space-based, airborne, and ground vehicle homing, or in convoy settings. When used by ground vehicles to accomplish a convoy relationship, the function is sometimes referred to as “leader-follower.” The installation of an mLADF sensor system can be physically separable from, and will operate irrespective of, the vehicle(s) with which it is used. Operation of the mLADF system does not require the source/leader or homing/follower vehicles to be in physical contact with each other.

In this inventive Example, line-of-sight (LOS) proximity between a respective source/leader and homing/follower pair is required since the capacity of the emitting assembly to illuminate the sensor assembly is being exploited. The mLADF sensor system operates irrespective of whether or not either the source/leader or homing/follower vehicles are inhabited or uninhabited.

An example of a ground vehicle, leader-follower application is as follows.

The present inventor wanted a simpler solution than the complex solutions proposed by others for vehicular leader-follower technologies in which complex EO and IR cameras, LIDAR, RADAR and/or SONAR-based sensor systems were being proposed. The present inventor recognized that a simpler solution to leader-follower problem was possible.

Also, the present inventor recognized that leader-follower systems are a subset of the class of problems referred to as homing devices (which may occur in two, three, or four dimensions). An example of a homing system in two dimensions is a leader-follower ground vehicle configuration. An example of a homing system in three dimensions is a leader-follower configuration in which at least the follower vehicle is an aircraft or spacecraft. An example of a homing system in four dimensions is a homing system in three dimensions in which a time-based solution is adopted, such as a step-by-step (rather than a single step) implementation of automatic homing.

The inventive mLADF sensor system advantageously makes possible the reduction of costs (both computational and monetary) required by conventional LOS leader-follower technology. In addition, the simplicity resulting from a reduction in hardware complexity can make a leader-follower system easier to maintain and more reliable. The inventive mLADF system does so by simplifying the sensor-side of the leader-follower control problem to one of a direct read-out indication of “follower” vehicle lateral vector magnitude and longitudinal Pulse Width Modulated (PWM) displacements, respectively.

In this Inventive Example 1, the mLADF sensor system includes a fan-like array of multiple light sources positioned laterally along a convenience axis. (In the case of a ground vehicle leader-follower control problem, that axis would typically be horizontal.) The system of this Example uses two principles for its operation: “return to null” and “distance by triangulation.”

An example of an emitter and detector assembly is as follows.

mLADF Emitter Assembly 100

The emitter assembly 100 in this Example consists of a linear array of two independent banks of light sources 111, 112, 113, 114, 115, 121, 122, 123, 124, 125 which are laser emitters, arranged in a radial, fan-like pattern servicing a single, common axis (the NULL center line). Optically, the array is in two halves. The lasers in the respective “left” and “right” halves of the array emit unique frequencies of light, e.g., UV and IR light, and are controlled for current and temperature. Thus, the assembly emits multiple frequencies of light along a single, common axis. For simplicity, in this Example the number of frequencies of light is two, i.e., UV and IR. For example, a UV light frequency may be emitted by light sources 111, 112, 113, 114, 115 and an IR light frequency may be emitted by light sources 121, 122, 123, 124, 125. The frequency emitted by light sources 111, 112, 113, 114, 115 may be the same or different. Likewise, the frequency emitted by light sources 121, 122, 123, 124, 125 may be the same or different.

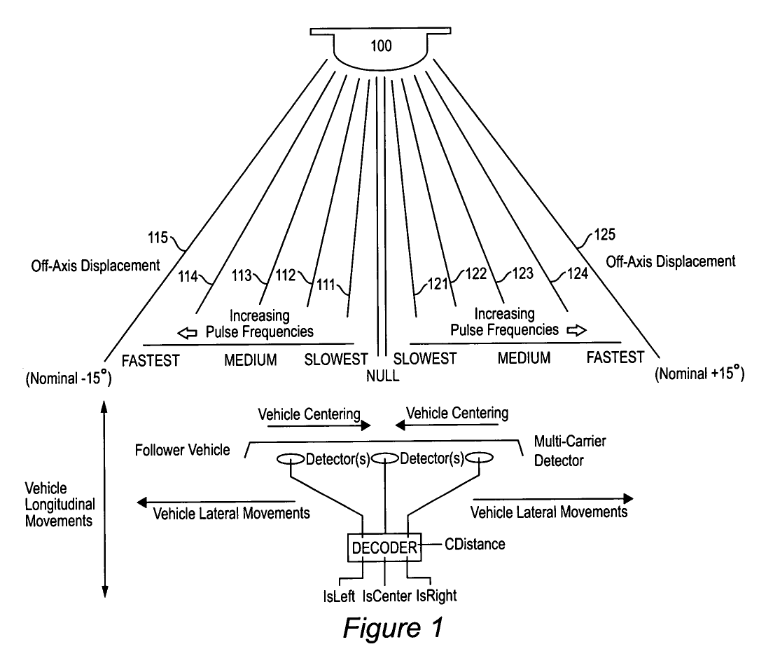

Along the array, each respective laser emitter is pulsed at a fixed rate dependent on its position in the array. The emitters at the opposing ends of the array are pulsed at relatively higher frequencies (such as, e.g., 115 and 125). The emitters are pulsed at relatively decreased frequency rates according to their placement towards the center of the array. Emitters in the center of the array are pulsed at “null” or low frequency. In FIG. 1, the Center Line is considered “null.”

For using the array in FIG. 1 to a leader-follower vehicular application, the total size of the transmitter system can be, for example, less than about a foot in the case of a truck. However, the size is not particularly limited and this size is only mentioned by way of example.

The electronics supporting the emitter functionality are straightforward. A series of fixed frequency pulse generators and light sources may be used.

The mechanical components are concerned with spacing, mounting, “potting,” and focusing (or collimation in the case of laser diodes). The emitter assembly can be either permanently mounted to a leader/source vehicle or affixed by a suitable temporary mount. In the case of a leader-follower example, the emitter preferably would be mounted to the rear and center of the leader vehicle.

Taken together, the mLADF emitter assembly of this Example 1 is an inexpensive, robust, and all-weather source of pulse-modulated information carried on two or more unique frequencies of light. In this case, mounted on the rear of a vehicle it provides a distinctive “leader” homing beacon.

mLADF Multi-Carrier Detector Assembly

The detector assembly in this Example 1 has a decoder that provides four distinct outputs: IsLeft, IsRight, IsCenter, and CDistance. These outputs are intended to reduce the computational requirements on any leader-follower, or continuously homing, control system by providing direct read-out indication of follower lateral vector magnitude and longitudinal Pulse Width Modulated (PWM) displacements, respectively.

By placing three (or more) Multi-Carrier Detectors on the front of a follower (homing) vehicle, the relative lateral position of the “follower” with respect to the “leader” can be quickly ascertained. The presence (or absence) of the two or more pulsed frequencies of light emitted by the MLADF emitters provides positive indication of lateral position. Similarly, by using simple electronic counters and/or active peak detection circuitry, an all-digital output corresponding to the longitudinal vector magnitude of the “homing” follower, with respect to the “source” leader, can be produced.

The electronics to support the detector functionality are straightforward. There may be used a logic device called a field programmable gate array (FPGA), a microcontroller, and mixed signal electronic components.

The mechanical components for the detector are for spacing, mounting, “potting,” and focusing. The assembly can be either permanently mounted to the front of a “homing” follower vehicle or be affixed by a suitable temporary mount. The detector assembly optionally can be in two distinct parts: a decoder part and a Multi-Carrier Detector part. Whether the detector assembly is one-piece or two-piece does not affect its function.

Referring to FIG. 1, it should be appreciated that a nominal number of radial lines is shown; more radial lines (i.e., more laser diodes) would be used to obtain finer granularity, i.e., finer positioning. In FIG. 1, leftness/rightness is used as a basic operational concept. Radial lines extend from the sender (i.e., the emitter 100). The further the following vehicle is from the left or the right, a different tone is obtained. With a high speed computer, processing pulse IR, the receiver can adjust. The computer speed to use, it will be appreciated, depends upon the frequency(ies) to be processed. For example, a crude version of the invention may be constructed with two frequencies being processed, in which case relatively little computing speed would be needed but the left/right steering would be hard steering. On the other hand, if high-speed computing is used, then finer steering can be accomplished. Features of the emitter array 100 in FIG. 1 are that it resolves longitudinal displacement (Fore, Aft) and resolves lateral motion (Left, Right, Center).

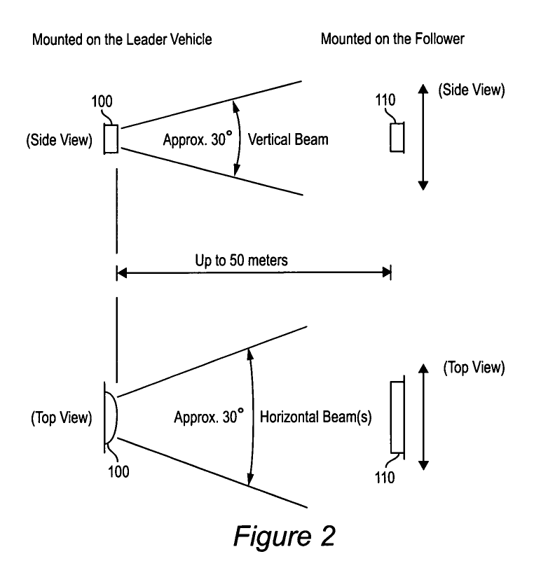

Referring to the emitter array 100 (mounted on the leader vehicle) of FIGS. 1 and 2, some preferred features are as follows. Preferably, the emitter array 100 is mounted on the leader vehicle using a mounting bracket integrated to a heat sink and ground. Mounting of the emitter array 100 may be accomplished with standard threaded fasteners. For emitter array 100, a single wire interface may be just voltage. For example, a potted metal frame with laser diodes in it may be used, with a mounting bracket made of metal. Simplicity of construction, in which emitter array 100 in this invention may be simply connected to a wire, may be advantageous.

Referring to the detector array 110 (mounted on the follower vehicle) of FIGS. 1 and 2, some preferred features are as follows. The detector array 110 preferably is robust vertically and robust horizontally. The outputs of the detector preferably are entirely digital, and are: IsLeft, IsRight, IsCenter, C Distance (each is PWM Distance Output).

The size and shape of the assembly for the receiving aspect of the invention is not particularly limited and depends upon the vehicle on which the detector assembly is positioned. For example, in the case of a truck, there may be used sensors on a strip, with distal placement (to support triangulation).

Some advantages of the present invention will be immediately appreciated. For example, realistic, simple automated homing in ground vehicles in leader-follower configuration (as can be provided by the present invention) makes possible unmanned status for follower vehicles which is particularly advantageous in dangerous situations and/or where an alternative to human operators may be wanted.

### Inventive Example 1A

### (Three Dimensions)

FIGS. 1 and 2 can be extended to three-dimensional space, such as, for example, in a case where a second ship is homing in on a first ship. By mounting an additional emitter on the first ship, homing can be accomplishing in a up/down direction as well as in a left/right direction. Therefore, velocity of the second ship also can be controlled.

A preferred use of the present invention is to deploy automated robotic-type vehicles, especially in convoys and especially in dangerous situations, without needing human operators. Convoys of vehicles in leader-follower configuration advantageously may be operated without needing human operators in the follower vehicles. It will be appreciated that the invention additionally has other uses and applications.

While the invention has been described in terms of preferred embodiments, those skilled in the art will recognize that the invention can be practiced with modification within the spirit and scope of the appended claims.

Having thus described my invention, what I claim as new and desire to secure by Letters Patent is as follows:

1. An automatic homing method, comprising at least the steps of:
emitting light of at least two different frequencies; and
automatically detecting the emitted light.

2. The homing method of claim 1, wherein the light-emitting step is associated with a first object and the light-detecting step is associated with a second object, wherein the first object and second object are in vehicular leader-follower configuration.

3. The homing method of claim 2, wherein the first object and the second object are in line of sight (LOS) but are not in physical contact.

4. The homing method of claim 1, wherein the different-frequency light is emitted along a single, common axis.

5. The homing method of claim 4, wherein UV light and IR light are emitted along a single, common axis.

6. The homing method of claim 1, wherein the different-frequency light is emitted at the same time.

7. The homing method of claim 1, wherein light of one frequency is emitted at a different time than light of another frequency.

8. The homing method of claim 1, wherein the light-emitting step is performed by an array of light sources mounted on a central rear portion of a vehicle; and the light-detecting step is performed by an automatic sensor system mounted on a follower vehicle.

9. The homing method of claim 8, wherein the vehicles are inhabited or uninhabited, in any combination.

10. The homing method of claim 1, including at least one automated step selected from a return-to-null step and a distance-by-triangulation step.

11. An automatic direction finder system operating between at least a first object which is a leader object and a second object which is a follower object, wherein either or both objects may be moving, wherein the system comprises:
a multiple light automatic direction finder (mLADF) system in which multiple light sources are arrayed, the multiple light sources including at least a first-frequency emitting source and a second-frequency emitting source.

12. The automatic direction finder system of claim 11, wherein at least two different respective frequencies of light are emitted along a single, common axis.

13. The automatic direction finder system of claim of claim 12, wherein at least UV light and IR light are emitted along the single, common axis.

14. The automatic direction finder system of claim 13, wherein the multiple light sources are arrayed in a fan-like array.

15. The automatic direction finder system of claim 13, wherein the multiple light sources are positioned laterally along an axis.

16. The automatic direction finder system of claim 15, wherein the axis is horizontal and the mLADF system is in a ground vehicle leader-follower configuration.

17. The automatic direction finder system of claim 13, wherein the system includes at least a return-to-null system and/or a distance-by-triangulation system.

18. The automatic direction finder system of claim 17, wherein both return-to-null and distance-by-triangulation systems are included.

19. An automatic direction finder system operating between at least a first object which is a leader object and a second object which is a follower object, wherein either or both objects may be moving, wherein the system comprises:
a light source assembly that emits light; and
a multi-carrier detector assembly that senses light emitted by the light source assembly.

20. The automatic direction finder system of claim 19, including performance of direct read-out indication of lateral vector magnitude and longitudinal pulse width modulated (PWM) displacements for the follower object.

21. The automatic direction finder system of claim 19, wherein the first object and the second object are in line-of-sight (LOS) of each other, with the first object having associated with it the light source assembly and the second object having associated with it the detector assembly.

22. The automatic direction finder system of claim 19, wherein the automatic direction finder system includes a set of signaling outputs that encode longitudinal and lateral spatial relationships between the first object and the second object.

23. The automatic direction finder system of claim 22, wherein each of the at least two objects is selected from the group consisting of: self-propelled objects, ballistics objects, and tethered objects, and the at least two objects are in any combination.

24. The automatic direction finder system of claim 22, wherein the objects are inhabited vehicles or uninhabited vehicles.

25. The automatic direction finder system of claim 19, wherein the system is applied in a setting selected from the group consisting of space-based, airborne, ground vehicle homing and convoy.

26. The automatic direction finder system of claim 19, wherein the system is operated between two objects and the two objects are not required to be in physical contact with each other.

27. The automatic direction finder system of claim 19, wherein the two objects are ground vehicles in a leader-follower setting.

28. The automatic direction finder system of claim 19, wherein none of electro-optical (EO) sensors, infra-read (IR) cameras, LIDAR, RADAR or SONAR-based sensor systems is needed.

29. The automatic direction finder system of claim 19, wherein the light source assembly that emits light includes at least one selected from the group consisting of: incandescent lamps;
semiconductor light emitting diodes (LEDs); light pipes and laser diodes.

30. The automatic direction finder system of claim 19, wherein the light source assembly that emits light consists of a linear array of two independent banks of light sources arranged in a radial, fan-like pattern servicing a single, common axis.

31. The automatic direction finder system of claim 30, wherein optically the linear array is separated into two halves, with each half of the array emitting a respective unique frequency of light.

32. The automatic direction finder system of claim 31, wherein one half of the array emits UV light and the other half of the array emits IR light.

33. A homing device system, wherein none of electro-optical (EO), infra-red (IR) cameras, LIDAR, RADAR or SONAR-based sensor systems is needed.

34. The homing device system of claim 33, comprising a vehicular leader-follower system.

35. The homing device system of claim 33, wherein the system operates in two, three or four dimensions.

36. The homing method of claim 1, wherein the light emitting step is automated.

37. A homing system for leader-follower ground vehicles, comprising:
a leader ground vehicle from which is emitted at least one radio frequency;
a follower ground vehicle having an automatic detection device automatically detecting the at least one radio frequency emitted from the leader ground vehicle.

38. The homing system of claim 37, wherein only one frequency is emitted by the leader ground vehicle and the only one frequency is automatically detected by the automatic detection device, wherein the automatic detection device comprises a fast processor.

39. The homing system of claim 37, wherein at least two frequencies are emitted by the leader ground vehicle and the at least two frequencies are automatically detected by the automatic detection device.

40. The homing system of claim 37, wherein at least one light frequency is emitted and automatically detected.

41. The homing system of claim 40, wherein the light is laser light.

42. The automatic homing method of claim 1, the automatic detection of emitted light occurring at a moveable object having an adjustable course and the method including, after automatically detecting the emitted light, a step of automatically adjusting the course of the moveable object at which the automatic detection occurs.
